(19) United States
(12) Patent Application Publication
(10) Pub. No.: US 2014/0324735 A1
(43) Pub. Date: Oct. 30, 2014

(54) MAXIMIZING THE UTILITY OF INFORMATION IN MULTIPLE INTERSECTING DATA STRUCTURES USING PLATONIC SOLIDS AND RELATED POLYHEDRA AND POLYTOPES

(71) Applicant: INTERNATIONAL BUSINESS MACHINES CORPORATION, Armonk, NY (US)

(72) Inventors: Samuel Scott Adams, Rutherfordton, NC (US); Robert R. Friedlander, Southbury, CT (US); James R. Kraemer, Santa Fe, NM (US); Philip R. Varker, Tuckahoe, NY (US)

(73) Assignee: International Business Machines Corporation, Armonk, NY (US)

(21) Appl. No.: 13/869,190

(22) Filed: Apr. 24, 2013

(51) Int. Cl. G06Q 30/02

(52) U.S. Cl. CPC G06Q 30/0283
USPC 705/400

(57) ABSTRACT

A method, system and computer program product for maximizing the utility of data obtained from multiple intersecting data structures and stored in a multi-dimension information space. The method includes the steps of generating a rigid mathematical structure within the multi-dimensional information space; dividing the rigid mathematical structure into segments, each segment having a volume determined by a time of access to the segment relative to an event, a duration of access to the segment and a quantity of data in the segment; and determining a sellable price point for each segment of the rigid mathematical structure based on the volume of the segment.

### BACKGROUND

The present invention relates to data structures, and more specifically to maximizing the utility of information in data constructs using platonic solids or shapes and related polyhedra and polytopes.

Data structures are a particular way of storing and organizing data and provide a means of efficiently managing large amounts of data. Data structures may include linear data structures, graphs, hashes, trees and databases. The data of the data structures may include primitive data, composite data or abstract data.

Computing, managing, governing and determining a price of information in multiple intersecting data structures is difficult due to how the data may be structured in a specified solution set.

Platonic shapes or solids are regular, convex polyhedrons. The faces are congruent, regular polygons, with the same number of faces meeting at each vertex. A platonic solid could be a tetrahedron, cube or hexahedron, octahedron, dodecahedron, or an icosahedron. The platonic solids all possess three concentric spheres: the circumscribed sphere which passes through all the vertices, the midsphere which is tangent to each edge at the midpoint of the edge, and the inscribed sphere which is tangent to each face at the center of the face. The radii of these spheres are called the circumradius, the midradius, and the inradius, respectively. With these properties, the volume and surface area can also be calculated. The platonic solids are highly symmetrical with the vertices of each solid all being equivalent under the action of the symmetry group, as are the edges and faces.

### SUMMARY

According to one embodiment of the present invention a method for maximizing the utility of data obtained from multiple intersecting data structures and stored in a multi-dimension information space. The method comprising: a computer generating a rigid mathematical structure within the multi-dimensional information space; the computer dividing the rigid mathematical structure into segments, each segment having a volume determined by a time of access to the segment relative to an event, a duration of access to the segment and a quantity of data in the segment; and the computer determining a sellable price point for each segment of the rigid mathematical structure based on the volume of the segment.

According to another embodiment of the present invention, a computer program product for maximizing the utility of data obtained from multiple intersecting data structures and stored in a multi-dimension information space. The computer program product comprising: one or more computer-readable, tangible storage devices; program instructions, stored on at least one of the one or more storage devices, to generate a rigid mathematical structure within the multi-dimensional information space; program instructions, stored on at least one of the one or more storage devices, to divide the rigid mathematical structure into segments, each segment having a volume determined by a time of access to the segment relative to an event, a duration of access to the segment and a quantity of data in the segment; and program instructions, stored on at least one of the one or more storage devices, to determine a sellable price point for each segment of the rigid mathematical structure based on the volume of the segment.

According to another embodiment of the present invention, a system for maximizing the utility of data obtained from multiple intersecting data structures and stored in a multi-dimension information space. The system comprising: one or more processors, one or more computer-readable memories and one or more computer-readable, tangible storage devices; program instructions, stored on at least one of the one or more storage devices for execution by at least one of the one or more processors via at least one of the one or more memories, to generate a rigid mathematical structure within the multi-dimensional information space; program instructions, stored on at least one of the one or more storage devices for execution by at least one of the one or more processors via at least one of the one or more memories, to divide the rigid mathematical structure into segments, each segment having a volume determined by a time of access to the segment relative to an event, a duration of access to the segment and a quantity of data in the segment; and program instructions, stored on at least one of the one or more storage devices for execution by at least one of the one or more processors via at least one of the one or more memories, to determine a sellable price point for each segment of the rigid mathematical structure based on the volume of the segment.

### BRIEF DESCRIPTION OF THE SEVERAL VIEWS OF THE DRAWINGS

FIG. 1 depicts an exemplary diagram of a possible data processing environment in which illustrative embodiments may be implemented.

FIG. 2 shows a flowchart of a method of maximizing the utility of information in multiple intersecting data structures using platonic solids and related polyhedra and polytopes.

FIG. 3 shows an example of a platonic solid in a multi-dimensional information space.

FIG. 4 shows illustrates internal and external components of a client computer and a server computer in which illustrative embodiments may be implemented.

### DETAILED DESCRIPTION

The illustrative embodiments of the present invention recognize that due to the inherent properties of platonic solids, the volume and area can be determined in a repeated fashion as well as by dividing the solid into segments. The platonic solids can also represent information or data in n-dimensional space.

The illustrative embodiments of the present invention recognize that by placing information from intersecting data structures into a platonic solid or other similar shape, the data can be divided into segments and a price point and/or value of the data within the segment can be determined through surface area or volume of the segment of the platonic solid and is highly repeatable.

The illustrative embodiments of the present invention also recognize that a price point and/or value of information is time sensitive both in when access is granted and for how long access is granted for.

The illustrative embodiments of the present invention also recognize that the information or data from intersecting data constructs may be a result of a synthetic event. With a synthetic event being defined as a clustering of information based on preset parameters.

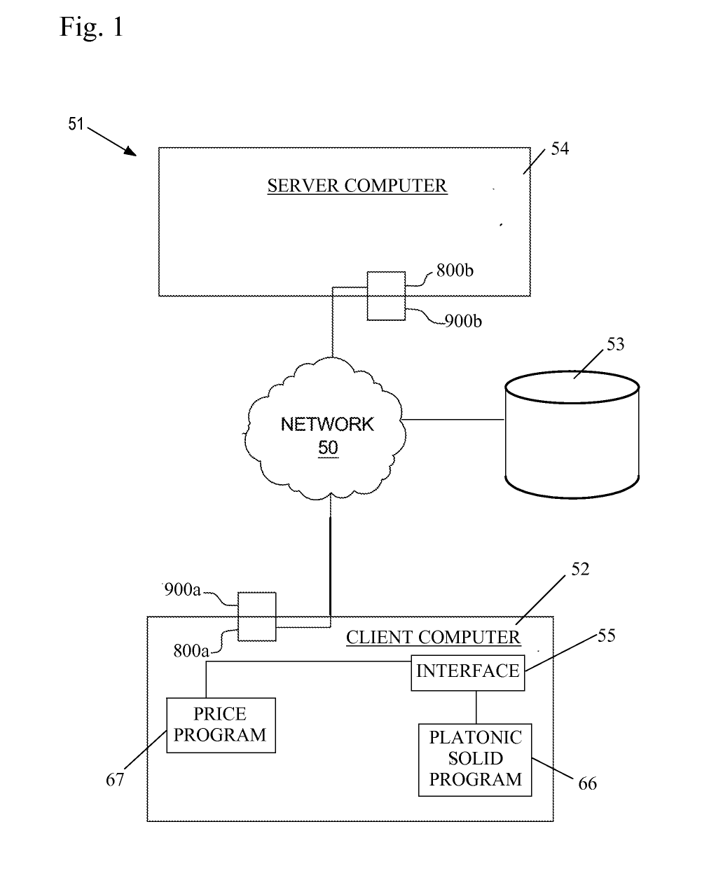

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

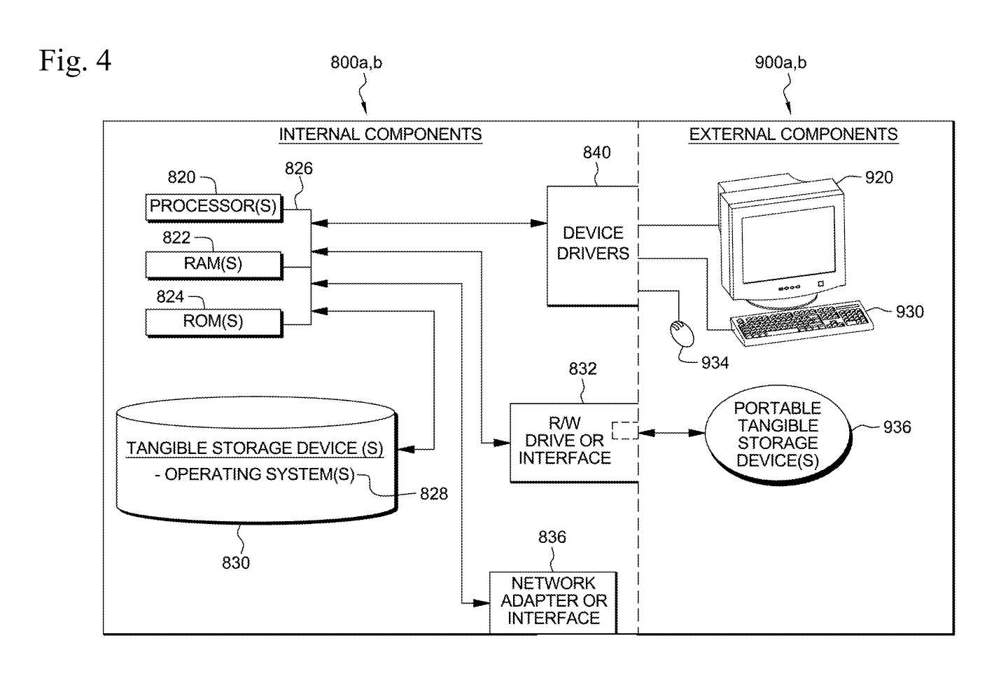

In the depicted example, client computer 52, repository 53, and server computer 54 connect to network 50. In other exemplary embodiments, network data processing system 51 may include additional client computers, storage devices, server computers, and other devices not shown. Client computer 52 includes a set of internal components 800a and a set of external components 900a, further illustrated in FIG. 4. Client computer 52 may be, for example, a mobile device, a cell phone, a personal digital assistant, a netbook, a laptop computer, a tablet computer, a desktop computer, or any other type of computing device.

Client computer 52 may contain an interface 55. Through the interface 55, multi-dimensional information space, synthetic events, data constructs, and platonic solids or shapes may be viewed by users. The interface 55 may accept commands and data entry from a user. The interface 55 can be, for example, a command line interface, a graphical user interface (GUI), or a web user interface (WUI) through which a user can access a platonic solid program 66 and a price program 67 on client computer 52, as shown in FIG. 1, or alternatively on server computer 54.

In the depicted example, server computer 54 provides information, such as boot files, operating system images, and applications to client computer 52. Server computer 54 can compute the information locally or extract the information from other computers on network 50. Server computer 54 includes a set of internal components 800b and a set of external components 900b illustrated in FIG. 4.

Program code, platonic shapes, synthetic events, and programs such as a platonic solid program 66 and a price program 67 may be stored on at least one of one or more computer-readable tangible storage devices 830 shown in FIG. 4, on at least one of one or more portable computer-readable tangible storage devices 936 as shown in FIG. 4, on repository 53 connected to network 50, or downloaded to a data processing system or other device for use.

For example, program code, platonic shapes, synthetic events and programs such as a platonic solid program 66 and a price program 67 may be stored on at least one of one or more tangible storage devices 830 on server computer 54 and downloaded to client computer 52 over network 50 for use on client computer 52. Alternatively, server computer 54 can be a web server, and the program code, platonic shapes and programs such as a platonic solid program 66 and a price program 67 may be stored on at least one of the one or more tangible storage devices 830 on server computer 54 and accessed on client computer 52. Platonic solid program 66 and price program 67 can be accessed on client computer 52 through interface 55. In other exemplary embodiments, the program code, platonic shapes, synthetic events, platonic solid program 66 and the price program 67 may be stored on at least one of one or more computer-readable tangible storage devices 830 on client computer 52 or distributed between two or more servers.

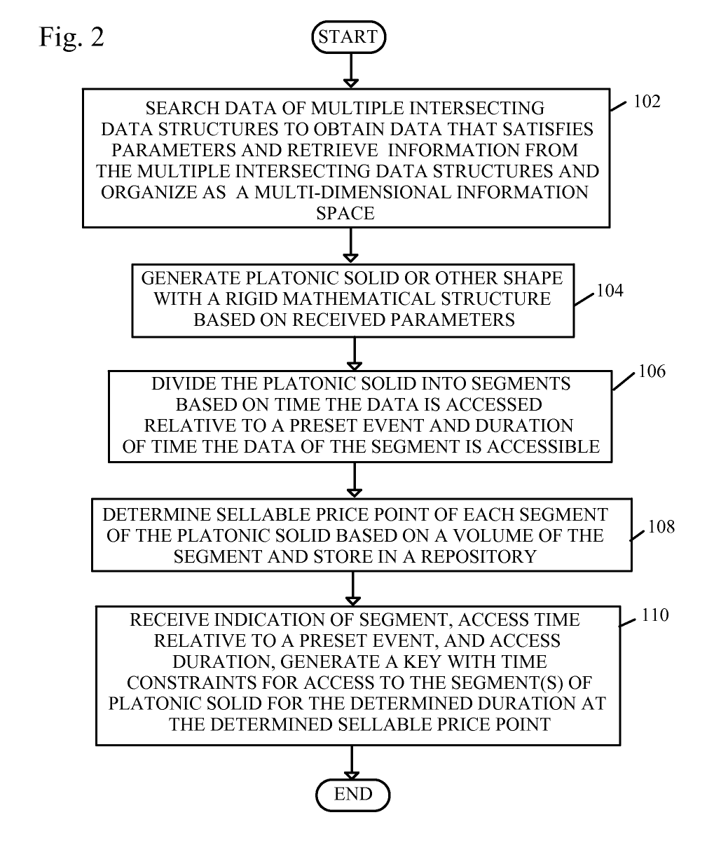

FIG. 2 shows a method for maximizing the utility of information in multiple intersecting data structures using platonic solids and related polyhedra and polytopes.

In response to parameters, for example a query, the platonic solid program 66 searches multiple data structures to obtain information or data that satisfies the parameters, retrieving the information from multiple intersecting data structures, and organizing it as a multi-dimensional information space (step 102). The multi-dimensional information space is then stored in a repository, for example repository 53. The multi-dimensional information space may be further characterized as a synthetic event, accounting for clustering of the information or data within the multi-dimensional information space.

From the multi-dimensional information space or synthetic event, a platonic solid or similar shape with a rigid mathematical structure is generated based on the parameters received (step 104), for example by the platonic solid program 66. The platonic solid or shape with rigid mathematical structure allows the information from the multi-dimensional information space or the synthetic event to be expressed in n-dimensions in n-space. Also, the properties of a platonic solid allow a consistent volume and area to be determined, and the platonic solid can be divided or segmented in a repeatable manner.

Next, the platonic solid or other shape is divided or segmented into segments, based on a time the data is accessed relative to a preset event and/or the duration of time for which the data is accessible, for example by the platonic solid program 66. The segments each have a surface area and a volume. The division or segmenting of the platonic solid is highly repeatable. The segments are stored (step 106) in a repository, such as repository 53.

A sellable price point is determined for each segment of the platonic shape based on the volume of the segment which represents the length of time (duration) the data in the segment is accessible, and the time of access to the data relative to the preset event, for example by the price program 67. The sellable price point is stored (step 108) in a repository, for example repository 53. An algorithm may be used to scale the volume of the segment relative to the duration of time the data in the segment is accessible, and/or the time of the data relative to a preset event.

For example, the data of the platonic solid might concern corn crop projections for the next growing season. A user may wish to access a segment of this data—a commodities trader might want to know the crop projection just a few days before corn futures for that growing season become available on the commodities market (the preset event), so that they can determine what they would pay for the futures. Or, an economist who is attempting to predict the general state of the economy would be less concerned with getting the information before the futures begin to be traded, and would be satisfied with access to the segment a month or two later. In this example, a higher sellable price point might be assigned to access to corn crop projections a few days before the preset event, than would be assigned to a segment of data regarding corn crop projections a month or two after the preset event.

Once an indication of a purchase of a segment of the platonic shape, access time relative to a preset event, and access duration is received, a key with time constraints is generated and presented for the user for access to the segment or segments of the platonic solid for the determined duration at the determined sellable price point (step 110), for example by the price program 67. The time constraints of the key allow the user access to the segment(s) of the platonic shape at a specific start date or time, and access is preferably discontinued at the end of the determined duration, i.e. at an end date or time. In some cases, an end date may not be set, allowing unending access to the data.

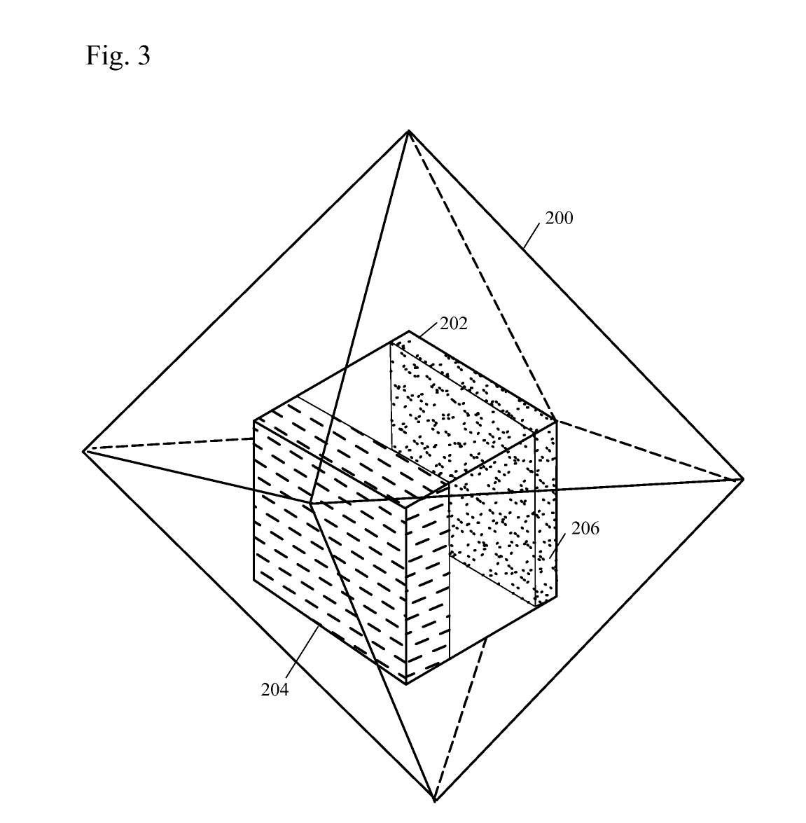

FIG. 3 shows an example of a representation of a multi-dimensional information space 200 with a platonic solid 202 within that space. If the platonic solid 202 was representative of an estimation of output or yield of an upcoming growing season for corn and soy beans, this data would be beneficial to numerous groups of people or users at different times, and for different durations of time. The groups of people that may be interested in the data are farmers, large companies producing products which are soy or corn-based, traders of commodities, government offices, etc. . . .

As described in the example above, the commodities trader, for example, would be interested in having access to this information for a short amount of time before the growing season, when futures are being traded, providing them with an advantage during the trading process. They would therefore purchase a large volume of data for a short amount of time, represented in this example by the volume of the dashed segment 204. The commodities trader would receive a key to gain access to the dashed segment 204 of the platonic solid only for, say, two days, one day prior to corn futures being traded. At the end of the two days the key expires and access is denied.

The economist, on the other hand, may wish to have access to all of the data in the platonic solid, but not until well after the growing season has passed, to compare it to other historical projections. He would need access to the data for a few years or even longer. The economist would receive a key to gain access to the entire platonic solid for the few years starting after the end of the growing season, and the key may remain valid for years—or he may even be given permanent access.

Other users, such as a fanner who will be growing the corn, may wish to have access to a subset of the data before the growing season—perhaps a small volume concerning only one county or state—but would not need access prior to futures being traded. The farmer might want access for a month, for example, to be able to plan how much corn to plant, etc. This is represented by the volume of the dotted segment 206. The farmer would receive a key granting access only to segment 206 of the platonic solid, which would expire a month later (or some other agreed-upon date).

The users who are trading commodities would have a higher price point than the farmer, for example, since the time prior to the event is less and the volume of the data is larger. With the price point being based on volume, the division of the platonic solid is easily repeatable.

FIG. 4 illustrates internal and external components of client computer 52 and server computer 54 in which illustrative embodiments may be implemented. In FIG. 5, client computer 52 and server computer 54 include respective sets of internal components 800a, 800b, and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, price program 67 and platonic solid program 66 are stored on one or more of the computer-readable tangible storage devices 830 for execution by one or more of the processors 820 via one or more of the RAMs 822 (which typically include cache memory). In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. A price program 67 and platonic solid program 66 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. A price program 67 and platonic solid program 66 can be downloaded to client computer 52 and server computer 54 from an external computer via a network (for example, the Internet, a local area network or other, wide area network) and network adapter or interface 836. From the network adapter or interface 836, a price program 67 and platonic solid program 66 are loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

A price program 67 and platonic solid program 66 can be written in various programming languages including low-level, high-level, object-oriented or non object-oriented languages. Alternatively, the functions of a price program 67 and platonic solid program 66 can be implemented in whole or in part by computer circuits and other hardware (not shown).

Based on the foregoing, a computer system, method, and program product have been disclosed for maximizing the utility of data obtained from multiple intersecting data structures and stored in a multi-dimension information space. However, numerous modifications and substitutions can be made without deviating from the scope of the present invention. Therefore, the present invention has been disclosed by way of example and not limitation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for maximizing the utility of data obtained from multiple intersecting data structures and stored in a multi-dimension information space, comprising:
a computer generating a rigid mathematical structure within the multi-dimensional information space;
the computer dividing the rigid mathematical structure into segments, each segment having a volume determined by a time of access to the segment relative to an event, a duration of access to the segment and a quantity of data in the segment; and
the computer determining a sellable price point for each segment of the rigid mathematical structure based on the volume of the segment.

2. The method of claim 1, wherein the rigid mathematical structure is a platonic solid.

3. The method of claim 1, further comprising the steps of:
the computer receiving from a user an indication of a desired segment of the rigid mathematical structure, the desired time of access and the desired duration of access;
the computer presenting the user with access to a segment of the rigid mathematical structure at the time of access and for the duration of access, at the determined sellable price point by providing a key with time constraints for access to the segment.

4. The method of claim 3, wherein the time constraints comprises an access start time and an access end time.

5. A computer program product for maximizing the utility of data obtained from multiple intersecting data structures and stored in a multi-dimension information space, the computer program product comprising:
one or more computer-readable, tangible storage devices;
program instructions, stored on at least one of the one or more storage devices, to generate a rigid mathematical structure within the multi-dimensional information space;
program instructions, stored on at least one of the one or more storage devices, to divide the rigid mathematical structure into segments, each segment having a volume determined by a time of access to the segment relative to an event, a duration of access to the segment and a quantity of data in the segment; and
program instructions, stored on at least one of the one or more storage devices, to determine a sellable price point for each segment of the rigid mathematical structure based on the volume of the segment.

6. The computer program product of claim 5, wherein the rigid mathematical structure is a platonic solid.

7. The computer program product of claim 5, further comprising program instructions, stored on at least one of the one or more storage devices, to:
receive from a user an indication of a desired segment of the rigid mathematical structure, the desired time of access and the desired duration of access;
present the user with access to a segment of the rigid mathematical structure at the time of access and for the duration of access, at the determined sellable price point by providing a key with time constraints for access to the segment.

8. The computer program product of claim 7, wherein the time constraints comprises an access start time and an access end time.

9. A system for maximizing the utility of data obtained from multiple intersecting data structures and stored in a multi-dimension information space, the system comprising:
one or more processors, one or more computer-readable memories and one or more computer-readable, tangible storage devices;
program instructions, stored on at least one of the one or more storage devices for execution by at least one of the one or more processors via at least one of the one or more memories, to generate a rigid mathematical structure within the multi-dimensional information space;
program instructions, stored on at least one of the one or more storage devices for execution by at least one of the one or more processors via at least one of the one or more memories, to divide the rigid mathematical structure into segments, each segment having a volume determined by a time of access to the segment relative to an event, a duration of access to the segment and a quantity of data in the segment; and
program instructions, stored on at least one of the one or more storage devices for execution by at least one of the one or more processors via at least one of the one or more memories, to determine a sellable price point for each segment of the rigid mathematical structure based on the volume of the segment.

10. The system of claim 9, wherein the rigid mathematical structure is a platonic solid.

11. The system of claim 9, further comprising program instructions, stored on at least one of the one or more storage devices for execution by at least one of the one or more processors via at least one of the one or more memories, to:
receive from a user an indication of a desired segment of the rigid mathematical structure, the desired time of access and the desired duration of access;
present the user with access to a segment of the rigid mathematical structure at the time of access and for the duration of access, at the determined sellable price point by providing a key with time constraints for access to the segment.

12. The system of claim 11, wherein the time constraints comprises an access start time and an access end time.
